(19) United States
(12) Patent Application Publication
(10) Pub. No.: US 2001/0019209 A1
(43) Pub. Date: Sep. 6, 2001

(54) Device on a conduit end and arrangement for joining conduits

(76) Inventors: Bengt I. Larsson, Skivarp (SE); Viveca Svensson, Trelleborg (SE)

Correspondence Address: WARREN B. KICE, Haynes and Boone, LLP, 901 Main Street, Suite 3100, Dallas, TX, 75202-3789, US

(21) Appl. No.: 09/779,971

(22) Filed: Feb. 9, 2001

Related U.S. Application Data
(63) Continuation-in-part of application No. 09/315,272, filed on May 20, 1999, now Pat. No. 6,217,084.
Application No. 09/315,272 is a continuation of application No. PCT/SE97/01823, filed on Oct. 30, 1997.

(30) Foreign Application Priority Data
Nov. 21, 1996 (SE) 9604278-3

(51) Int. Cl. F16L 37/00

(52) U.S. Cl. 285/305

(57) ABSTRACT

A device on a conduit end for joining the conduit (1) to a coupling (4) or some other receiver of the end of the conduit, which is made of aluminum or an aluminum alloy. Two external annular beads (2, 2′) are pressed out from the conduit wall on the conduit end and accommodate between themselves an O-ring (3). In an arrangement for joining, the receiver (4) has a conical inlet and means, which together with the rear annular bead (2) form engaging means for a tightening means.

### DETAILED DESCRIPTION

The present invention relates to a device on a conduit end and an arrangement for joining conduits.

Many methods are known for joining components for fluid pipes, e.g. conduits. One method aims at welding or soldering collars in/to the conduit ends, between which collars a flat packing is clamped by means of bolts which are screwed through flanges attached to the conduits. The bolts must be forcefully tightened so as to achieve a satisfactory seal. In another method, conical sockets instead of collars are welded/soldered to the conduit ends which are joined by means of corresponding conical couplings, the conduits and the coupling being also in this case interconnected by means of bolts that are screwed through flanges. Sealing is effected by means of O rings arranged in grooves in the sockets. Obviously the methods require a relatively large number of components and relatively great efforts and are cost-intensive also for the reason that a relatively expensive material, such as copper, brass or steel, must be used. A less expensive piping is obtained with aluminium, use being made of conduits with protruding ends and coupling components which are die-cast and formed with threads but which must be machined owing to the fact that small tolerances are required for obtaining a satisfactory seal with the flat packing when the fluid has operating pressure. The machining operation involves a risk that the die-cast material obtains pores, thereby causing leakage in the coupling component.

An object of the invention is to provide a device which permits joining of conduits in an inexpensive and efficient manner and which does not result in a reduction of the inner cross-section of the conduits which are joined together.

The object is achieved by a device and an arrangement according to the claims.

The invention will now be described in more detail with reference to the accompanying drawings, in which

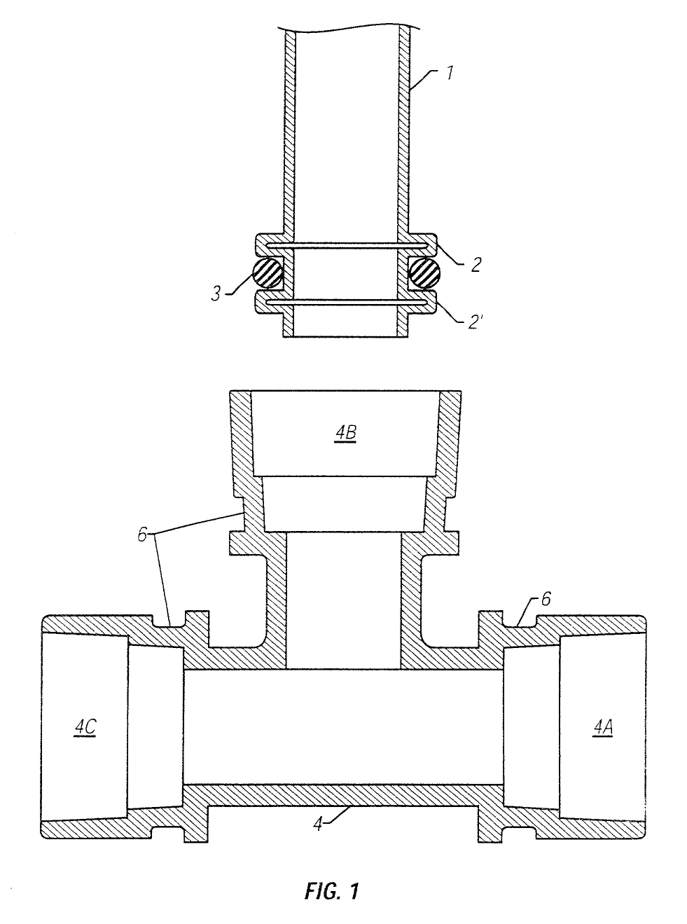

FIG. 1 is longitudinal section of a longitudinal part of a conduit and a longitudinal section of a T-shaped pipe coupling,

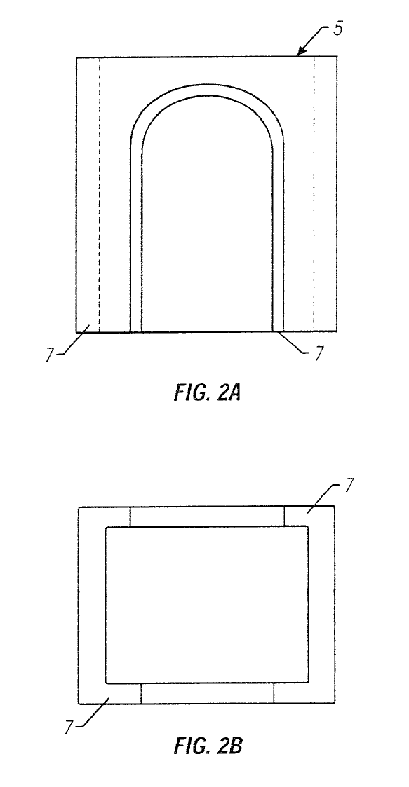

FIGS. 2a and 2b are a side view and a top plan view of a joining rider, and

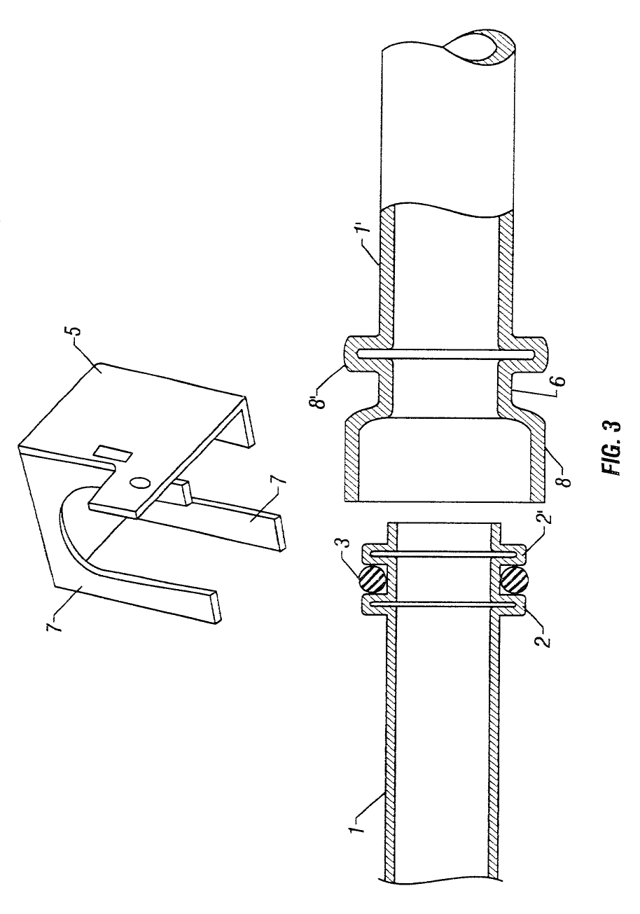

FIG. 3 is a view illustrating the principle of the invention applied to two conduits, which are shown in longitudinal section, while the joining rider is shown in a perspective view.

Accordingly to the invention, the conduit 1 made of aluminium or an aluminium alloy is provided with two external annular beads 2, 2′ at its joining end, said beads being formed of the actual conduit wall in a bulging lathe. The space between the beads is adapted to receive an O ring seal 3, which is pulled over the outer bead 2′. The coupling 4 is, for instance, die-cast of aluminium and its inlets/outlets 4A-4C are somewhat conical. Since the O ring is locked by the beads 2, 2′, the coupling need not be machined to obtained a close tolerance for receiving the conduit, and radial seal is obtained between the conduit and the coupling without necessitating a great tightening force on the O ring. For easily releasable tightening after joining, use can be made of a rider 5, the legs 7 of which engage behind the inner bead 2 and in a groove 6 formed in the outside of the coupling. The front bead 2′ may consist of a widened end portion of the conduit 1.

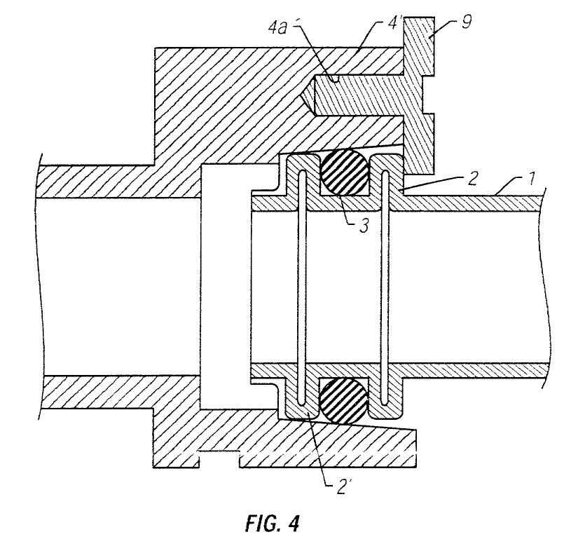

It will be appreciated that no coupling is required for connecting 4 two conduits. According to FIG. 3, the second conduit 1′ can, by pressure turning, be provided with a widened end portion 8 for receiving the end of the conduit 1, which is provided with the beads 2, 2′ and the O ring 3, and with, for instance, a posteriorly situated bead 8′ for forming the groove 6 for a rider leg 7 as described above. Furthermore, any suitable means other than a rider as above can be used for tightening, e.g. a self-threading screw 9, which is screwed into a bore 4′a formed in e.g. the wall of the coupling 4′, as shown in FIG. 4, the screw being substantially parallel with the connecting direction, the underside of the screw head or a washer being supported against the rear bead 2.

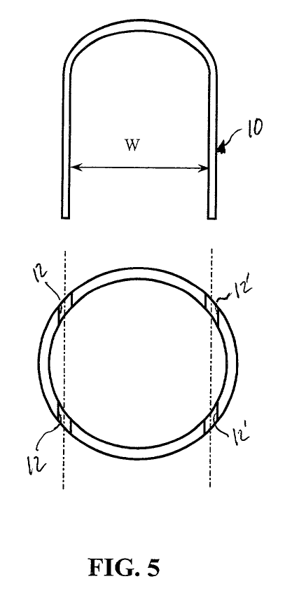

According to another preferred embodiment, (see FIG. 5) the two tubes are kept together by a U-shaped rider 10. The legs of the rider extend through holes 12, 12′ in the outer tube (such as the conduit 1′, or any of the receivers 4, 4′). The holes are axially disposed between the open end of the tube and the sealing connection with the sealing member placed between the beads in the inner tube (such as conduit 1), since there is no fluid flowing in this part of the tube.

Furthermore, the holes are arranged in pairs essentially in parallel with each other. The distance W between the legs of the rider is equal to (or slightly larger than) the outside diameter of the inner tube, but smaller than the outside diameter of the beads on the inner tube.

When the rider 10 above is used, firstly the inner tube is inserted into the outer tube and thereafter the rider is inserted into the holes in the outer tube. Thereby, the inner tube is retained in the outer tube, as the beads on the inner tube cannot get past the legs of the rider. In one embodiment, the O ring 3 engages the interior wall of the outer tube, the wall being optionally tapered inward, and once inserted in the holes, the legs of the rider 10 engage the rear bead (such as bead 2 in previous illustrations), to hold the tubes together in an interference fit.

According to this embodiment a releasable, but still secure tube connection is provided. Furthermore, the connection allows a slight angular adjustment between the two tubes, wherein the connection remains tight and secure.

According to a preferred embodiment the rider 10 comprises a steel wire, having a diameter in the range of 5 mm and being bent to the U-shape. The holes in the outer tube have a diameter slightly larger to provide easy insertion but still retain the rider. The legs of the rider or the holes can be slightly out of parallel, such that when the legs of the rider are inserted in the holes the rider is strained and thus retained on the outer tube.

1. A fluid distribution system comprising an annular receiver having an axial bore, a conduit having an end for disposing in the receiver bore, the end having first and second external annular beads formed in a spaced relationship thereupon for receiving a sealing member therebetween for engaging the receiver bore to form a seal, and means for detachably retaining the conduit end in the receiver.

2. The fluid distribution system of claim 1 wherein the means for detachably retaining the conduit end in the receiver comprises a rider comprising a first set of legs for engaging the first bead of the conduit and a second set of legs for engaging an external groove of the receiver.

3. A fluid distribution system comprising an annular coupling having an axial bore and an external groove, a conduit having an end for disposing in the coupling bore, the end having first and second external annular beads formed in a spaced relationship thereupon, a sealing member for engaging the coupling bore to form a seal, the member disposed between and engaging the first and second annular beads, and a rider for detachably retaining the conduit end in the coupling, the rider comprising a first set of legs for engaging the first bead of the conduit and a second set of legs for engaging the groove of the coupling.

4. A fluid distribution system comprising an annular coupling having an inwardly tapered axial bore and an external groove, a conduit having an end for disposing in the bore, the end comprising a first annular bead formed on an external surface of the conduit, and a second annular bead formed on an external surface of the conduit in a spaced relation to the first bead, a sealing member for engaging the coupling bore to form a seal, the member disposed between and engaging the first and second annular beads, and a rider comprising a first set of legs for engaging the first bead of the conduit and a second set of legs for engaging the groove of the coupling, thereby detachably retaining the conduit end in the coupling.

5. A fluid distribution system comprising an annular coupling having an inwardly tapered axial bore and a pair of axial openings, a conduit having an end for disposing in the bore, the end comprising a first annular bead formed on an external surface of the conduit, and a second annular bead formed on an external surface of the conduit in a spaced relation to the first bead, a sealing member for engaging the coupling bore to form a seal, the member disposed between and engaging the first and second annular beads, and a U-shaped rider comprising a set of legs for inserting into the axial openings, thereby engaging the first bead of the conduit and detachably retaining the conduit end in the coupling.
